(19) United States
(12) Patent Application Publication
(10) Pub. No.: US 2024/0349942 A1
(43) Pub. Date: Oct. 24, 2024

(54) FOOD THAWING CABINET AND RELATED METHOD

(71) Applicant: ILLINOIS TOOL WORKS INC., Glenview, IL (US)

(72) Inventors: Henry L. NGUYEN, Fort Worth, TX (US); Steven T. JACKSON, Fort Worth, TX (US)

(21) Appl. No.: 18/626,987

(22) Filed: Apr. 4, 2024

Related U.S. Application Data
(60) Provisional application No. 63/551,553, filed on Feb. 9, 2024.
(60) Provisional application No. 63/582,370, filed on Sep. 13, 2023.
(60) Provisional application No. 63/497,331, filed on Apr. 20, 2023.

(51) Int. Cl. A47J 39/00; A23L 3/365

(52) U.S. Cl. CPC A47J 39/006; A47J 39/003

(57) ABSTRACT

A food thawing apparatus includes a first thawing chamber and a second thawing chamber alongside the first thawing chamber, an upright divider wall between the chambers, wherein the first thawing chamber includes a back side, a front side, an exterior lateral side spaced from the divider wall and an interior lateral side adjacent the divider wall, wherein the second thawing chamber includes a back side, a front side, an exterior lateral side spaced from the divider wall and an interior lateral side adjacent the divider wall. A plurality of air movers are located in or on the divider wall and are positioned and operable such that a looped air flow path, in top plan view, is created, through the first and second chambers.

### TECHNICAL FIELD

The present application relates generally to cabinets utilized for thawing frozen foods and, more particularly, to a food thawing cabinet for rapidly thawing frozen foods in a controlled manner.

### BACKGROUND

It is known to provide thawing cabinets for thawing frozen food products in commercial environments such as restaurants and cafeterias. Achieving high speed thawing is an important consideration. Air flow over the food products is a critical feature to effective and timely food thawing.

It would be desirable to provide a cabinet that enhances thawing and improves upon the thawing time achievable in food thawing cabinets.

### SUMMARY

In one aspect, a food thawing apparatus includes a cabinet structure defining a first thawing chamber and a second thawing chamber alongside the first thawing chamber, the cabinet structure having an upright divider wall between the first thawing chamber and the second thawing chamber, wherein the first thawing chamber includes a back side, a front side, an exterior lateral side spaced from the divider wall and an interior lateral side adjacent the divider wall, wherein the second thawing chamber includes a back side, a front side, an exterior lateral side spaced from the divider wall and an interior lateral side adjacent the divider wall. A plurality of air movers are located in or on the divider wall, wherein the plurality of air movers are positioned and operable such that a looped air flow path, in top plan view, is created, wherein the looped air flow path comprises air flow in a first lateral direction along the back side of each of the first and second thawing chambers and through the divider wall, an air flow forwardly along the exterior lateral side of the first thawing chamber, an air flow in a second lateral direction along the front side of each of the first and second thawing chambers and through the divider wall, and an air flow rearwardly along the exterior lateral side of the second thawing chamber.

In another aspect, a food thawing apparatus includes a cabinet structure defining a first thawing chamber and a second thawing chamber alongside the first thawing chamber, the cabinet structure having an upright divider wall between the first thawing chamber and the second thawing chamber, wherein the first thawing chamber includes a back side, a front side an exterior lateral side spaced from the divider wall and an interior lateral side adjacent the divider wall, wherein the second thawing chamber includes a back side, a front side an exterior lateral side spaced from the divider wall and an interior lateral side adjacent the divider wall. The apparatus includes a plurality of fans made up by a first set of fans and a second set of fans, the first set of fans arranged along a rearward portion of the divider wall and spaced apart from each other vertically along a height of the divider wall, the second set of fans arranged along a forward portion of the divider wall and spaced apart from each other vertically along the height of the divider wall, wherein the apparatus is configured to operate in a first mode in which the first set of fans are operated to move air in a first lateral direction from the first thawing chamber to the second thawing chamber and the second set of fans are operated to move air in a second lateral direction from the second thawing chamber to the first thawing chamber.

In another aspect, a food thawing apparatus includes a cabinet structure defining thawing chamber having a back side, a front side, a first lateral side and a second lateral side. A plurality of fans are arranged to create a plurality of looped air flow paths along respective heights of the thawing chamber, wherein the apparatus is configured to operate in a first mode in which the fans are operated to move air along the looped air flow paths in a first loop direction and a second mode in which the fans are operated to move air along the looped air flow paths in a second loop direction.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is perspective view of a thawing apparatus;

FIG. 2 is a top plan view of the thawing apparatus;

FIG. 3 is a front elevation view of the apparatus with trayed products loaded in the thawing chambers;

FIG. 4 is a top perspective with product loaded in the chambers;

FIG. 5 is a partial section perspective showing exemplary flows within the thawing chambers;

FIG. 6 is a top schematic of air flow;

FIG. 7 is a front elevation schematic of air flow during operation of the evaporator blower(s);

FIGS. 8-16 show an embodiment of a thawing apparatus with a duct structure to deliver cooled air from the refrigeration system into both thawing chambers; and

FIGS. 17-36 show another embodiment of a thawing apparatus.

### DETAILED DESCRIPTION

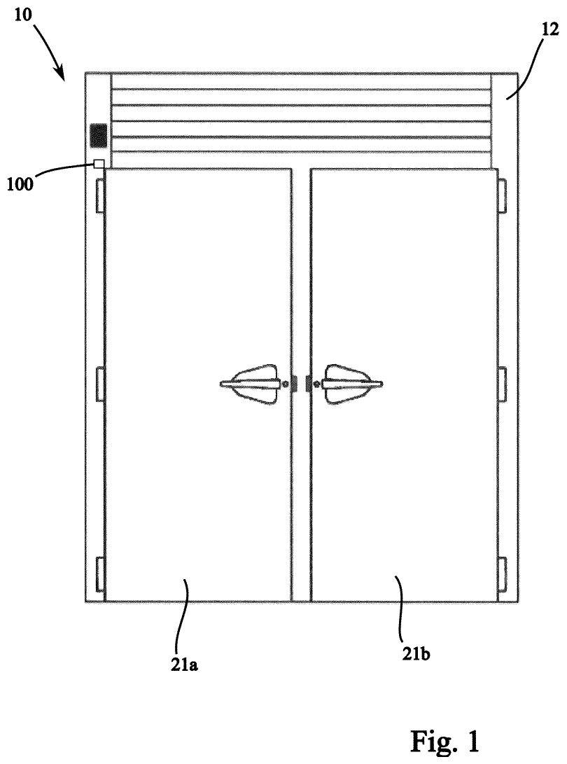

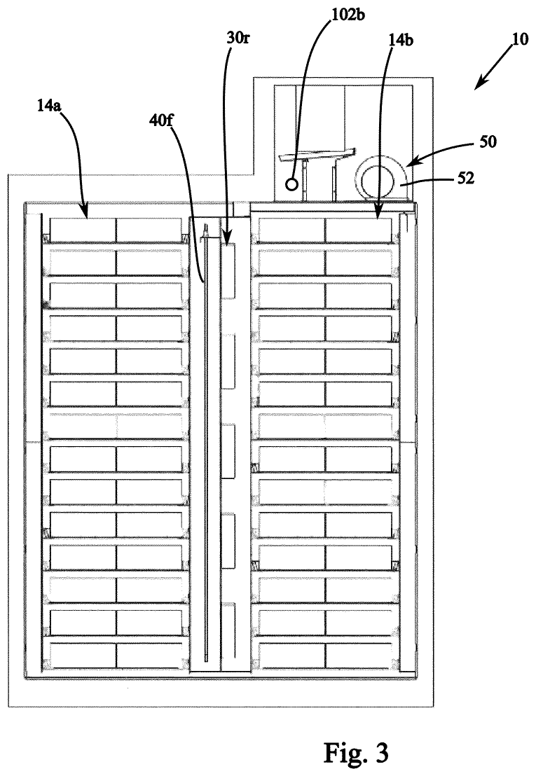

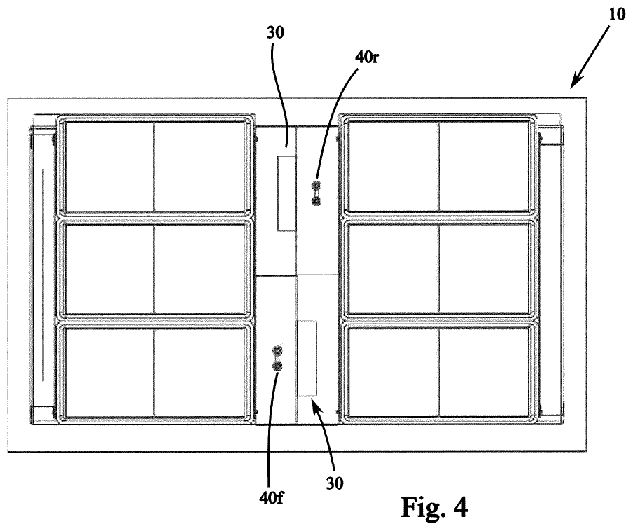

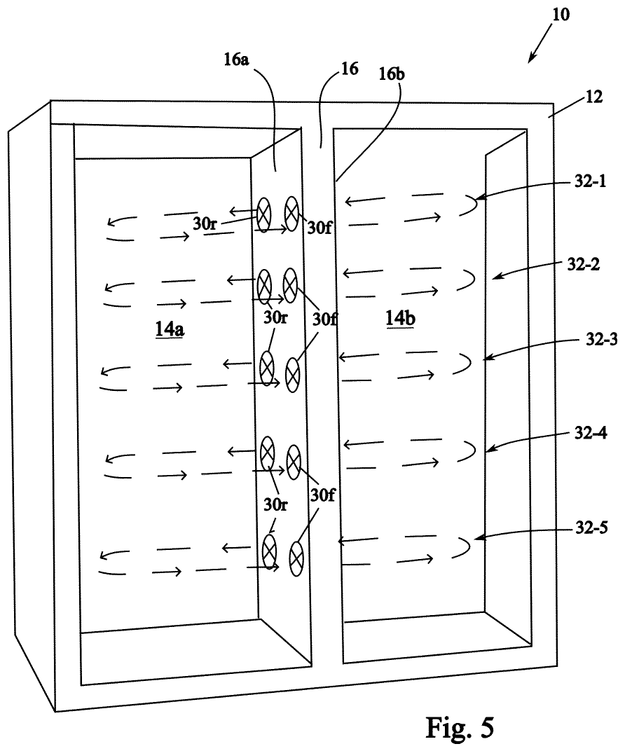

Referring to FIGS. 1-7, a food thawing apparatus 10 includes a cabinet structure 12 (e.g., formed by a frame with external and internal panels, between which insulation may be provided) with side-by-side internal thawing chambers 14a and 14b that are separated by an internal divider wall 16 (aka mullion) of the cabinet structure. Each thawing chamber 14a, 14b includes a respective back side 18a, 18b, front side 20a, 20b, exterior lateral side 22a, 22b spaced from the divider wall 16 and interior lateral side 24a, 24b adjacent the divider wall. Tray supporting racking structure is located at the exterior and interior lateral sides of each of the thawing chambers. A refrigeration system 50 is located atop the cabinet, and includes a condenser section and an evaporator section, and, when operated, draws air from the chamber(s) for cooling, and moves the air back into the chamber 14b via blower(s) 52. In an alternative embodiment, the refrigeration system could be bottom mounted.

Here, left right doors 21a, 21b are provided for enabling access to the chambers 14a, 14b. The divider wall 16 includes a left wall panel 16a and right wall panel 16b. A plurality of air movers 30 are located in or on the divider wall 16, with the air movers positioned and operable such that a primary looped air flow path 32, in top plan view, is created and comprises air flow 32a in a first lateral direction along the back side of each of the thawing chambers 14a, 14b and through the divider wall 16, an air flow 32b forwardly along the exterior lateral side 22a of the thawing chamber 14a, an air flow 32c in a second lateral direction along the front side of each of the thawing chambers 14a, 14b and through the divider wall 16, and an air flow 32d rearwardly along the exterior lateral side 22b of the thawing chamber 14b. The actual air flow within the chambers will typically be more complex than that depicted. For example, flows depicted by arrows 32e may also exist.

The air movers 30 are also arranged vertically to create multiple air flow circuits vertically spaced apart and that follow the looped path. Here, the air movers comprise a plurality of axial fans made up by a rear set of axial fans 30r and a forward or front set of axial fans 30f. The rear set of axial fans 30 are arranged along a rearward portion of the divider wall 16 and spaced apart from each other vertically along a height of the divider wall, and the forward set of axial fans 30f are arranged along a forward portion of the divider wall 16 and spaced apart from each other vertically along the height of the divider wall. The rear fans and the front fans are arranged at similar spacings and heights such that multiple fan pairs (e.g., one rear fan and one front fan) are located at multiple, respective heights. The multiple air flow circuits are generally shown as looped flows 32-1 to 32-5. Here five vertically spaced axial fans are provided in each set, but the number could vary, such as only four (or less) or six or more, which would result in a corresponding number of looped flow circuits at different elevations. It is recognized that some leakage or mixing of the air between the various air flow circuits is also regularly occurring, which helps assure more uniform temperature conditions throughout the thawing chambers for the purpose of thawing the food product.

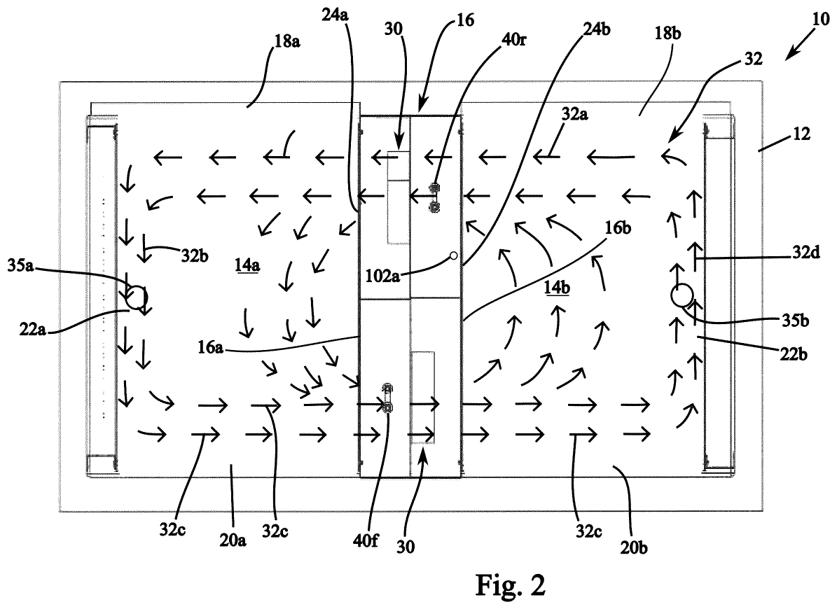

In embodiments, the looped flow in the direction shown may be per operation of the thawing apparatus in a first fan direction mode in which the rear set of axial fans 30r are operated to move air in the lateral direction (per flow 32a) and the forward set of fans 32f are operated to move air in the opposite lateral direction (per flow 32c). The apparatus may include a controller 100 that enables different modes as well. As used herein, the term controller is intended to broadly encompass any circuit (e.g., solid state, application specific integrated circuit (ASIC), an electronic circuit, a combinational logic circuit, a field programmable gate array (FPGA)), processor(s) (e.g., shared, dedicated, or group—including hardware or software that executes code), software, firmware and/or other components, or a combination of some or all of the above, that carries out the control functions of the device or the control functions of any component thereof. The apparatus may be configured, by way of the controller 100, to switch from the first fan direction mode to a second fan direction mode based upon a set parameter, such as a first time condition. In the second fan direction mode, the rotation direction of the axial fans is reversed, such that the rear set of axial fans 30r create a flow from left to right (in the view FIG. 2) and the forward set of axial fans 30f create a flow from right to left (in the view of FIG. 2). The first time condition may be running of a set time period, such as in the range of five to fifteen minutes. The thawing apparatus may be configured, by way of the controller 100, to switch back from the second fan direction mode back to the first fan direction mode based upon a second time condition, which may be running of another set time period that is the same as, or different than, the first set time period. The purpose of reversing the air flow direction is to eliminate or reduce the impact of any stagnating areas of flow and to periodically assure that the product receiving the hottest and fastest air flow is switched back and forth.

In this regard, heating elements 40r and 40f are associated with the axial fans. In FIG. 4, the heating elements are located on the inlet side of the axial fans, but in other embodiments, the heating elements could be located on the outlet side of the axial fans. In one implementation, each fan may have a corresponding individual heating element. In another embodiment, vertical heating elements (e.g., U-shaped heating elements) may run the height of the internal duct area of the divider wall 16. Horizontally oriented heating elements are also possible. The heating elements are controlled, by way of configuration of the controller 100, to achieve desired temperature conditions in the air flow through the chambers 14a, 14b, based upon one or more temperature sensors (e.g., sensors 102a and/or 102b) indications. The number and location of the temperature sensors utilized can vary. In some embodiments, one or more additional heating elements may be provided in regions 35a and 35b, near the exterior lateral sides of the chambers, for supplemental heating of air that has cooled after passing over product on the outflow from the fan(s) and before passing back in the opposite direction as intake to the other fan(s).

The apparatus may be configured for operation in multiple different cooling/heating modes, such as a standard refrigeration mode (state 0—in which the refrigeration system and its blower(s) 52 operate to maintain a desired temperature setpoint in the chambers, but the air movers 30 do not operate), a primary thawing mode (state 1—in which the refrigeration system and its blower(s) 52 are off, and the air movers 30 and heating elements 40f, 40r operate to add and circulate heat for thawing) and a secondary thawing mode (state 2—in which the refrigeration system and its blower(s) 52 operate, and air movers 30 operate, with the heating elements 40f, 40r off, to bring temperature back into desired thawing range in the case of overshoot). The apparatus may use the temperature sensors to trip between states (e.g., in a “Continuous Mode”). A “Batch Mode” is also possible, where both time and temperature sensing are used to determine the states.

One exemplary state sequence is sequence state 0, then state 1, then state 2, then state 0. This sequence would typically occur where a user fully loads the unit with frozen product all at once. Another exemplary state sequence is state 0, then state 1, then state 2, then state 1. This sequence might occur if the user removes a portion of thawed product and replaces it with frozen (e.g., where ⅓ of the cabinet is fully thawed, ⅓ is in the process of thawing and ⅓ is completely frozen). In embodiments, in the refrigeration mode and secondary thawing mode (states 0 and 2), the refrigeration system delivers cooled air into the thawing chambers, but in the primary thawing mode (state 1), the refrigeration system does not operate to cool, but the refrigeration system (via evaporator hump air mover) delivers heated air into the thawing chambers (e.g., via operation of one or more duct heating elements and/or one or more heating elements associated with the blowers 52).

In one example, the controller will trigger into a thawing mode when the cabinet temperature drops below a thaw setpoint (e.g., of 34° F.) for a set hysteresis time period (e.g., 2-4 minutes). The hysteresis is used to prevent tripping into, or out of, thawing mode prematurely based upon a transient condition, such as door opening. Once in thawing mode, the controller will cause adding of heat using the heating elements 40f, 40r and/or supplementary heaters until the cabinet temperature reaches a defined temperature (e.g., the thaw setpoint plus a thaw differential, of for example a 3-5° F.). Thus, a thaw setpoint of 34° F. and thaw differential of 4° F. would result in terminating the thaw mode at 38° F. The controller then establishes a holding mode where the cooling setpoint is slightly higher than the thaw setpoint (e.g., cooling setpoint of 35° F. with a 3° F. cooling differential, such that temperature will be held between 35° F. and 38° F.). A second cooling setpoint can also be used for economy savings or for a recooling mode.

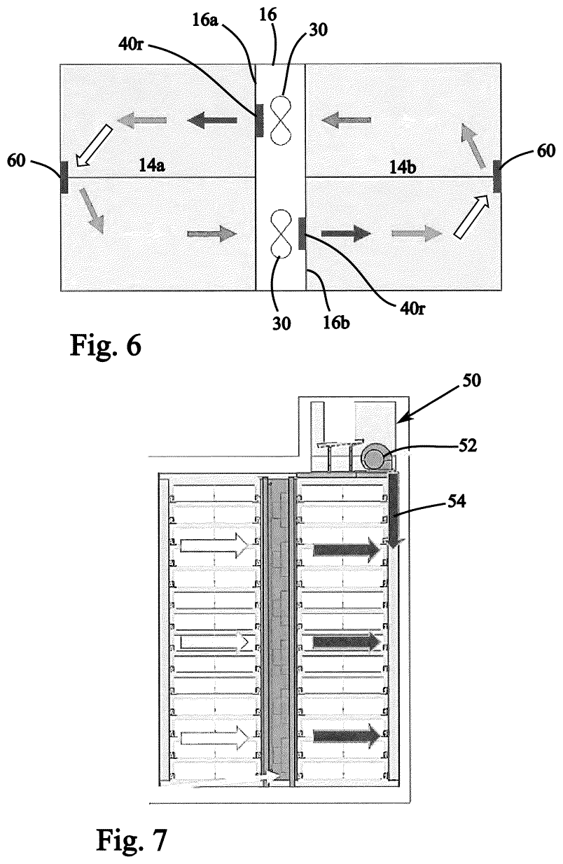

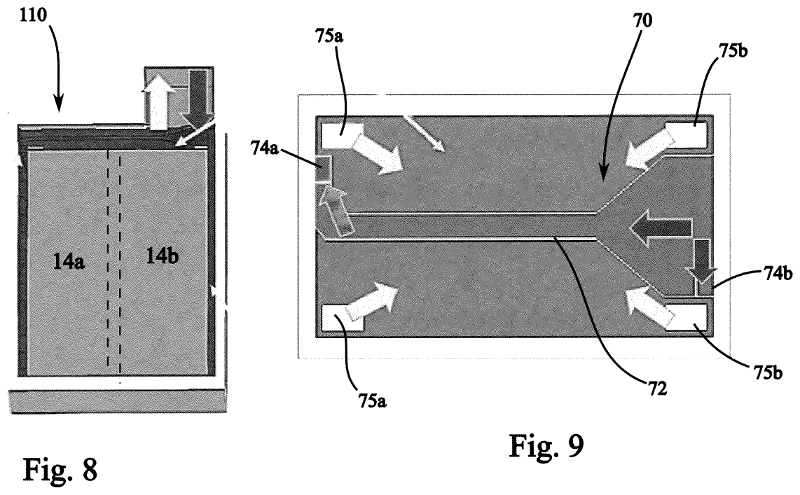

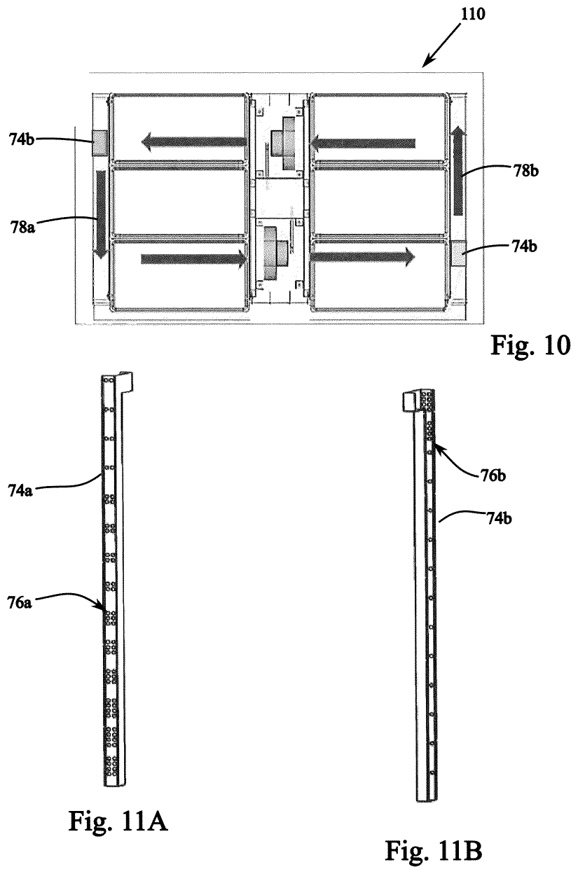

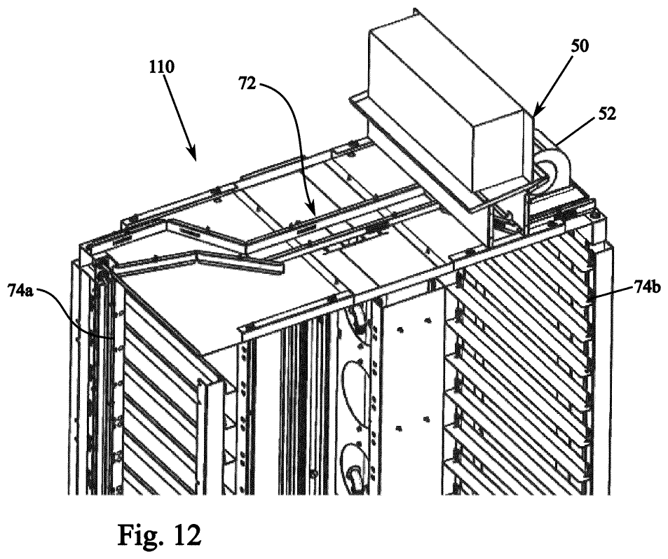

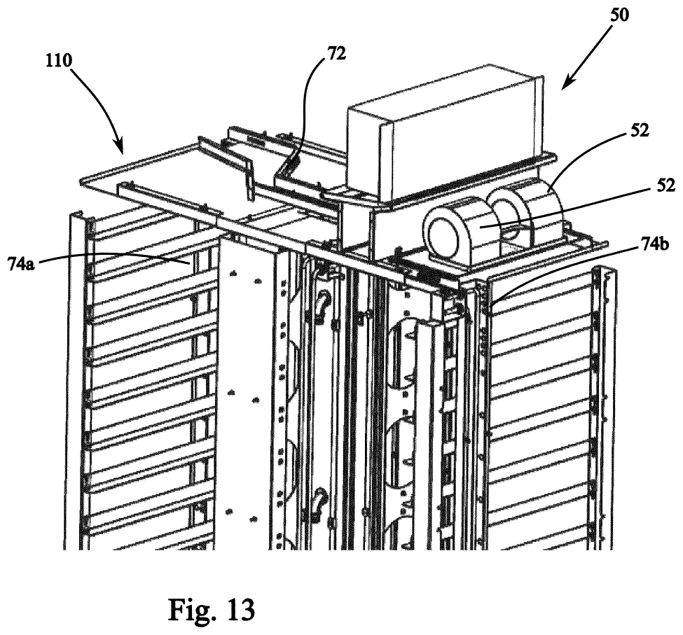

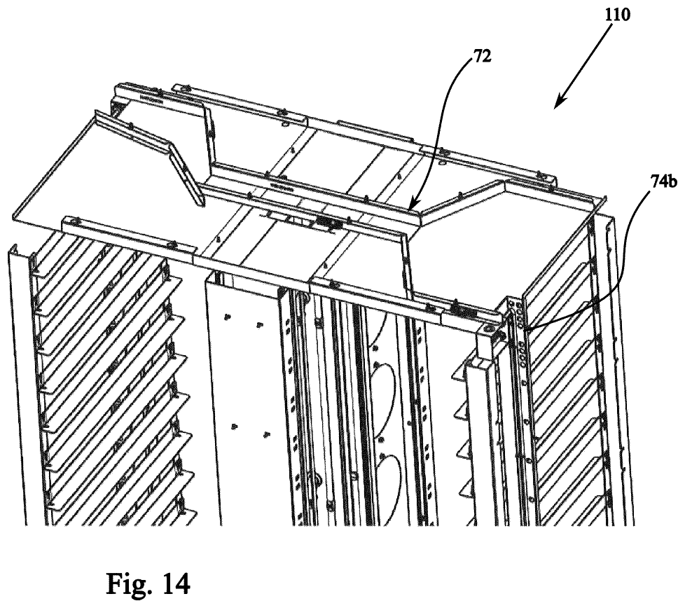

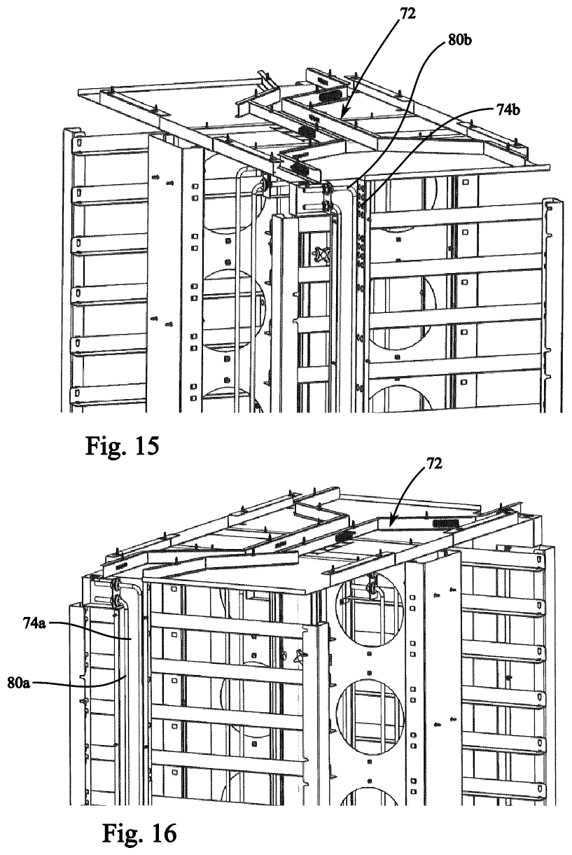

As seen in FIGS. 6-7, the axial fans 30 and heating elements 40f, 40r in the mullion 16 are the main source of airflow and heat transfer, operating to push air in a looped flow path (from the top view). At the far left and right edges of the airflow, the additional heaters 60 are selectively operated to re-supply the airflow with heat. During the thawing phase, the evaporator blower(s) 52 is/are not running. During a cooling phase (e.g., to prevent the heat added via thawing from causing the chamber temperatures to overshoot), the evaporator blowers 52 provide airflow back into the chamber 14b in a downward direction, perpendicular to the main air flow loops, per arrow 54. This may cause an imbalance of air velocity, temperature, and pressure at the top right section when the evaporator blower(s) and the axial fans are on at the same time, preventing the cold air from being efficiently distributed to the rest of the cabinet when the cabinet is full. The embodiment depicted in FIGS. 8-16 addresses this potential issue.

Per FIGS. 8-16, another embodiment of a thawing apparatus 110 includes the looped air flows as described above, the direction of which may be changed by changing the operating direction of the axial fans. An air duct system 70 is provided to direct the evaporator blower exhaust air to both the left side of chamber 14a and the right side of chamber 14b and to distribute the mass flow more evenly into each shelf level. The air duct system includes a top duct structure 72 that feeds the cooled air down into both a left vertical duct 74a and a right vertical duct structure 74b. This configuration adds higher velocity along the left and right sides of the cabinet, improves heat transfer of the supplementary heaters on the sides, and distributes the cooling air throughout the entire cabinet. The return paths for air to the refrigeration system are via the left top corner regions 75a of the chamber 14a and the right top corner regions 75b of the chamber 14b.

Each vertical duct structure includes outlet openings 76a, 76b oriented to deliver the cooling air directionally consistent with the looped air flow path(s) (e.g., out of the door facing side of vertical duct 74a, per arrow 78a, and out of the rear racing side of vertical duct 74b, per arrow 78b). The outlet hole pattern 76a and 76b of the two vertical ducts 74a and 74b is different and adapted to provide substantially equal flows through the two vertical ducts. Because duct 74a is further away from the fan source it requires a different hole pattern than duct 74b column to provide substantially equal distribution to all the shelves in both chambers (e.g., varying the number of holes of various sizes per shelf location, generally increasing in total flow area toward the bottom). The airflow that is moving to the left through the top duct 72 and vertical duct 74a meets with extra resistance due to the friction of the walls. This resistance will lower the total mass flow rate out of vertical duct 74a. The hole pattern in duct 74a is made different from that of vertical duct 74b to improve the distribution of air flow through each shelf of chamber 14a.

Each vertical duct structure may also include one or more heating element(s) 80a, 80b therein, positioned to heat the duct wall so that heat can be added to the looped air flows (via the duct walls) during thawing (e.g., during state 1 as described above)

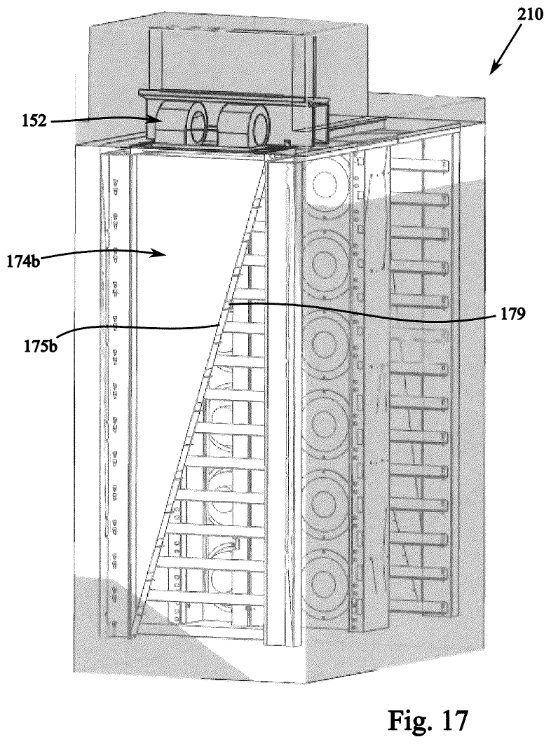

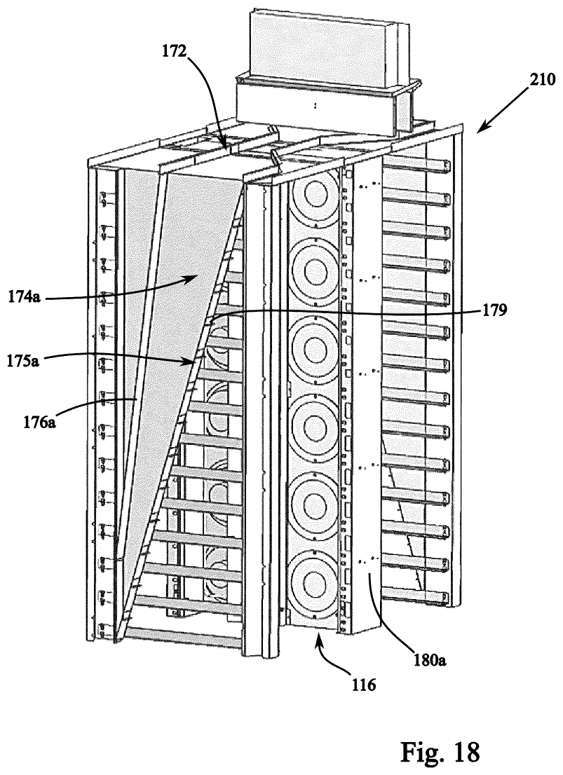

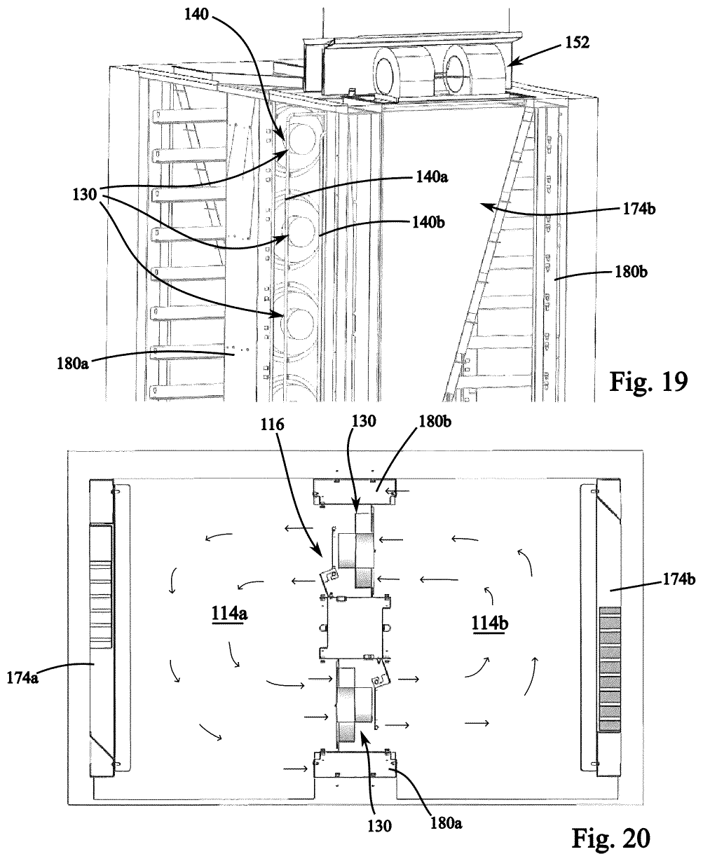

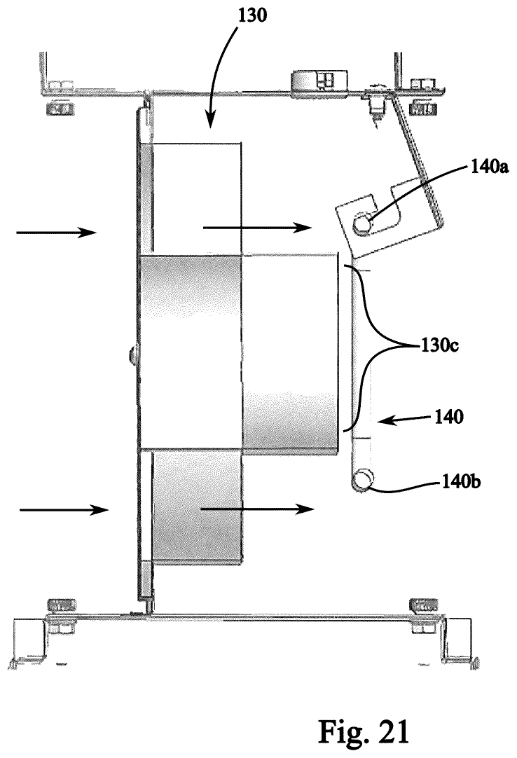

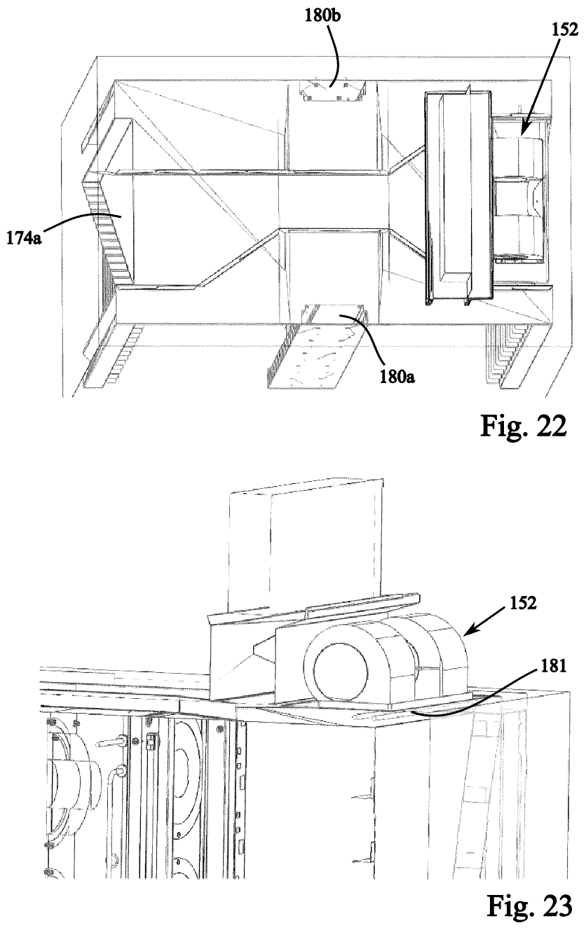

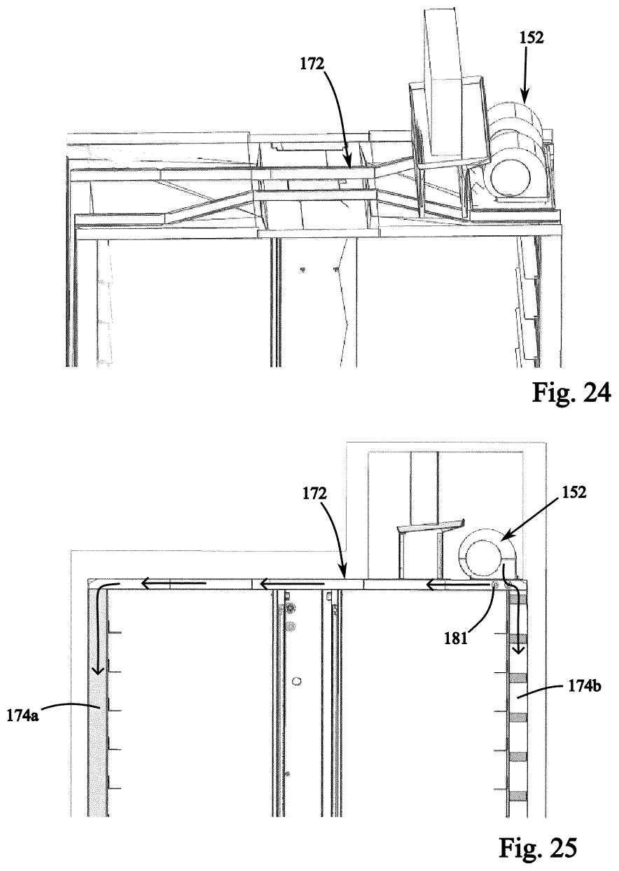

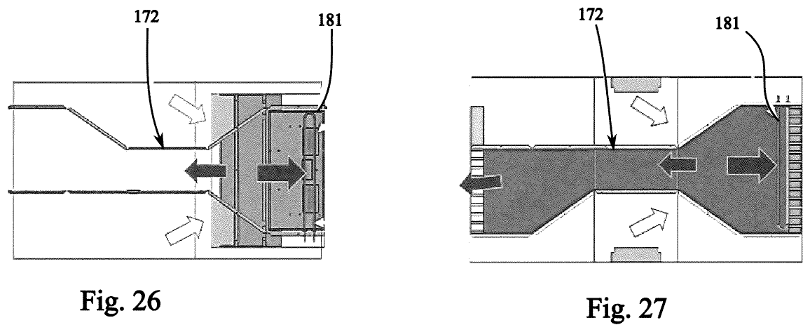

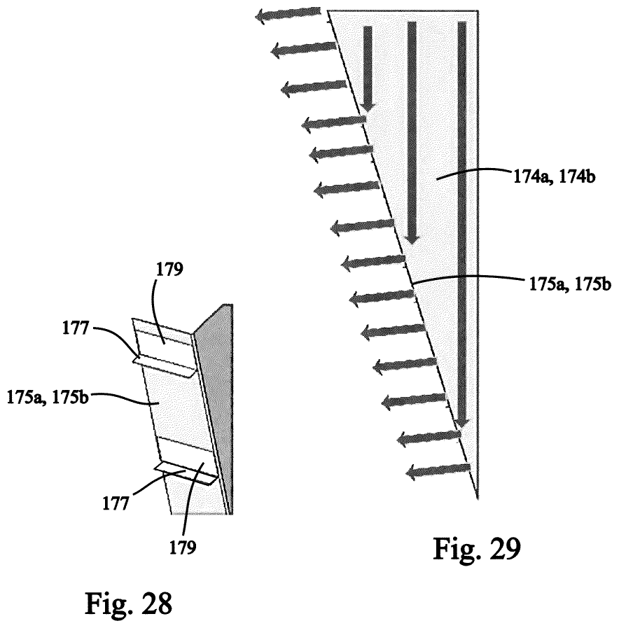

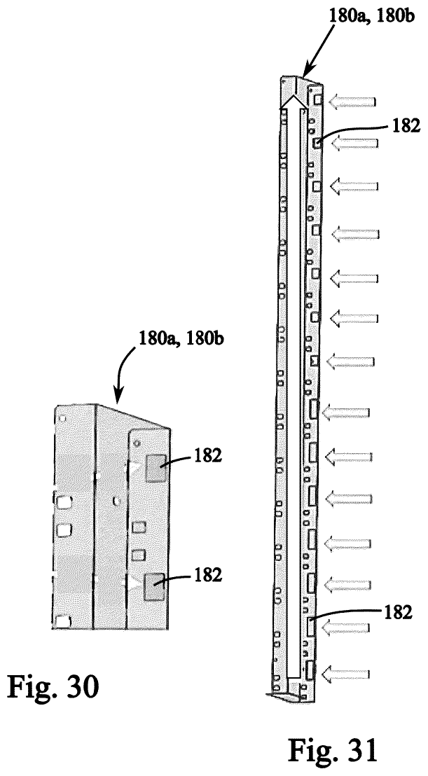

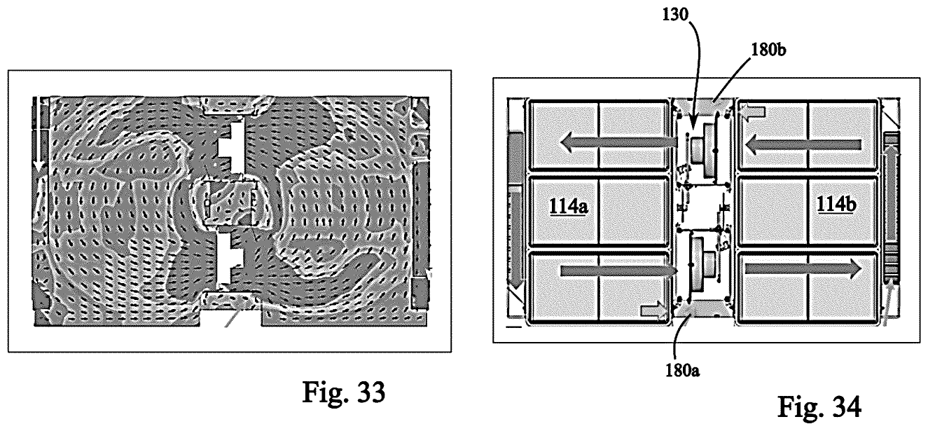

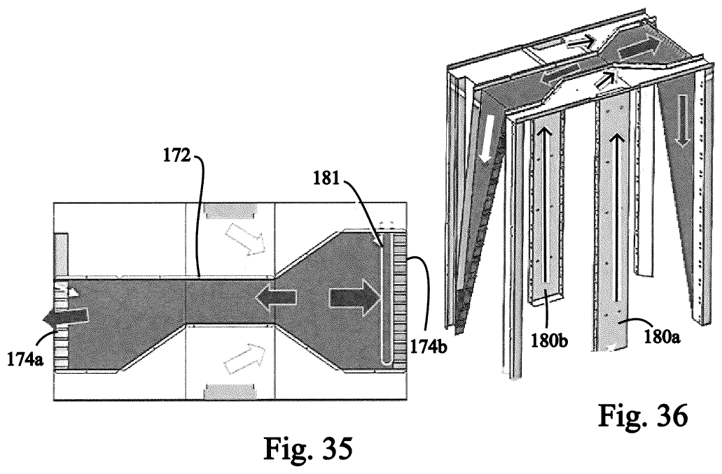

Referring now to FIGS. 17-36, another embodiment of a thawing apparatus 210 similar to the above embodiment of FIGS. 8-16 is shown, with a number of variations. Again, apparatus 210 includes the previously described looped air flows, the direction of which may be changed by changing the operating direction of the axial fans. Here, the left vertical duct 174a and the right vertical duct 174b are configured with respective triangle shapes with the outlet wall 175a, 175b of each duct inclined (i.e., running in a direction that is offset from both vertical and horizontal) to help the vertically downward airflow along the ducts to transition into an exiting horizontal airflow without losing too much velocity. The outlet walls 175a and 175b each also include tabs 177 at the bottom edges of the outlet holes 179 of the outlet wall that act as baffles to allow the vertical airflow to better deflect into the horizontal airflow. Here, the tabs 177 extend outwardly from the external side of the ducts. Notably, the outlet holes 179 are angled relative to the main downward flow direction within the vertical ducts due to the inclined orientation of the outlet walls 175a, 175b. The top air duct structure 172 feeds air from the evaporator blower(s) 152 to each of the vertical ducts 174a and 174b. Here, rather than having heating elements in the vertical ducts 174a and 174b, a heating element 181 is provided at the outlet side of the blower(s) 152 such that the air is heated before it reaches the vertical ducts on the left and right sides. The size of the exhaust/outlet holes 179 of the left and right ducts varies in a manner to more evenly distribute the air in line with the air flow created by the axial fans 130 (e.g; holes for each shelf location increase in size/total flow area towards the bottom). The airflow that is moving to the left through the top duct 172 and vertical duct 174a meets with extra resistance due to the friction of the walls. This resistance will lower the total mass flow rate out of vertical duct 174a. The hole pattern in duct 174a is made different from that of vertical duct 174b to improve the distribution of air flow through each shelf of chamber 114a. Because the left vertical duct 174a is located farther from the blower 152, the duct volume is smaller (e.g. due the position and orientation of duct wall 176a) than the volume of duct 174b to boost velocity.

With respect to the front and rear axial fans 130, located in the center mullion 116, the heating elements 140 are arranged for heating the air driven by such fans and, here, are located on the downstream side of the fans relative to the primary air movement direction of each vertical set of axial fans. Additionally, the vertical legs (e.g., 140a, 140b) of each heating element are located in the main air flow stream of the axial fans 130, by being spaced laterally of the central region 130c of the axial fans, where much less air flow occurs.

Here, the return air flow from the thawing chambers 114a, 114b back up to the evaporator blower(s) 152 is along vertical intake ducts/channels 180a, 180b located at the front side and the rear side of the central mullion 116. The intake channels have different sized inlet holes 182 along their vertical height to pull in air from each shelf area with a more equal distribution from top to bottom along the channel height. In this regard, the inlet holes are generally larger at the bottom of the channel than at the top of the channel. The primary inlet holes for each channel are on the side of the channel that faces against the direction of air flow in the chambers. The channels ensure that airflow is mixing/moving out of all the shelves so that fresh air can go into the shelves.

It is to be clearly understood that the above description is intended by way of illustration and example only, is not intended to be taken by way of limitation, and that other changes and modifications are possible. For example, thawing apparatus with a single thawing chamber with vertically stacked looped air flows, and two different fan direction modes, are possible. In such cases, a vertical air duct for returning cooled air from the refrigeration system to the thawing chamber, directionally consistent with the looped air flow, could also be provided, and such a vertical duct could include a supplementary heater.

1. A food thawing apparatus, comprising:
a cabinet structure defining a first thawing chamber and a second thawing chamber alongside the first thawing chamber, the cabinet structure having an upright divider wall between the first thawing chamber and the second thawing chamber, wherein the first thawing chamber includes a back side, a front side an exterior lateral side spaced from the divider wall and an interior lateral side adjacent the divider wall, wherein the second thawing chamber includes a back side, a front side an exterior lateral side spaced from the divider wall and an interior lateral side adjacent the divider wall;
a plurality of air movers located in or on the divider wall, wherein the plurality of air movers are positioned and operable such that a looped air flow path, in top plan view, is created, wherein the looped air flow path comprises an air flow component in a first lateral direction along the back side of each of the first and second thawing chambers and through the divider wall, an air flow component forwardly along the exterior lateral side of the first thawing chamber, an air flow component in a second lateral direction along the front side of each of the first and second thawing chambers and through the divider wall, and an air flow component rearwardly along the exterior lateral side of the second thawing chamber.

2. The food thawing apparatus of claim 1, wherein the plurality of air movers comprises a plurality of fans made up by a first set of fans and a second set of fans, the first set of fans arranged along a rearward portion of the divider wall and spaced apart from each other vertically along a height of the divider wall, the second set of fans arranged along a forward portion of the divider wall and spaced apart from each other vertically along the height of the divider wall, wherein the apparatus includes a controller configured to operate in a first mode in which the first set of fans are operated to move air in the first lateral direction and the second set of fans are operated to move air in the second lateral direction to produce the looped air flow path.

3. The food thawing apparatus of claim 1, wherein the plurality of air movers comprises at least one first fan located along a rearward portion of the divider wall and at least one second fan located along a forward portion of the divider wall.

4. The food thawing apparatus of claim 2, wherein the apparatus includes a controller configured to operate in a first mode in which the at least one first fan is operated to move air in the first lateral direction and the at least one second fan is operated to move air in the second lateral direction to produce the looped air flow path. wherein the controller is configured to operate in a second mode in which the at least one first fan is operated to move air in the second lateral direction and the at least one second fans is operated to move air in the first lateral direction to reverse the direction of the looped air flow path.

5. The food thawing apparatus of claim 4, wherein the controller is configured to switch from the first mode to the second mode based upon a first time condition and/or a first temperature condition.

6. The food thawing apparatus of claim 5, wherein the controller is configured to switch from the second mode back to the first mode based upon a second time condition and/or a second temperature condition.

7. The food thawing apparatus of claim 1, further comprising:
each of the air movers having a heating element proximate thereto on or in the divider wall at an upstream side or a downstream side of the air mover.

8. The food thawing apparatus of claim 7, further comprising:
one or more supplementary heating elements located at the exterior lateral side of the first thawing chamber;
one or more supplementary heating elements located at the exterior lateral side of the second thawing chamber.

9. The food thawing apparatus of claim 1, further comprising:
a refrigeration system operable for pulling air from at least one of the first and second thawing chambers, cooling the air and returning the air to both the first thawing chamber and the second thawing chamber.

10. The food thawing apparatus of claim 9, wherein a return air duct system associated with the refrigeration system includes (i) a first vertical duct within the first thawing chamber and having first air outlets distributed along a height of the first vertical duct and positioned such that cooling air exiting the first air outlets is directionally consistent with a portion of looped air flow path in the first thawing chamber and (ii) a second vertical duct within the second thawing chamber and having second air outlets distributed along a height of the second vertical duct and positioned such that cooling air exiting the second air outlets is directionally consistent with a portion of the looped air flow path in the second thawing chamber.

11. The food thawing apparatus of claim 10, wherein the return air duct system includes a top duct structure that distributes cooling air to both the first vertical duct and the second vertical duct.

12. The food thawing apparatus of claim 10, wherein the first vertical duct includes at least one supplementary heating element therein and the second vertical duct includes at least one supplementary heating element therein.

13. The food thawing apparatus of claim 10, wherein the first vertical duct is configured to reduce in flow area when moving downward and the second vertical duct is configured to reduce in flow area when moving downward.

14. The food thawing apparatus of claim 13, wherein the first vertical duct is triangular in shape in side elevation view and the second vertical duct is triangular in shape in side elevation view.

15. The food thawing apparatus of claim 13, wherein the first vertical duct includes outlet openings with associated flaps and the second vertical duct includes outlet openings with associated flaps.

16. A food thawing apparatus, comprising:
a cabinet structure defining a first thawing chamber and a second thawing chamber alongside the first thawing chamber, the cabinet structure having an upright divider wall between the first thawing chamber and the second thawing chamber, wherein the first thawing chamber includes a back side, a front side an exterior lateral side spaced from the divider wall and an interior lateral side adjacent the divider wall, wherein the second thawing chamber includes a back side, a front side an exterior lateral side spaced from the divider wall and an interior lateral side adjacent the divider wall;
a plurality of fans made up by a first set of fans and a second set of fans, the first set of fans arranged along a rearward portion of the divider wall and spaced apart from each other vertically along a height of the divider wall, the second set of fans arranged along a forward portion of the divider wall and spaced apart from each other vertically along the height of the divider wall, wherein the apparatus is configured to operate in a first mode in which the first set of fans are operated to move air in a first lateral direction from the first thawing chamber to the second thawing chamber and the second set of fans are operated to move air in a second lateral direction from the second thawing chamber to the first thawing chamber.

17. The food thawing apparatus of claim 16, wherein the first set of fans comprises at least five fans and the second set of fans comprises at least five fans.

18. The food thawing apparatus of claim 16, wherein the apparatus is configured to operate in a second mode in which the first set of fans are operated to move air in the second lateral direction and the second set of fans are operated to move air in the first lateral direction.

19. The food thawing apparatus of claim 18, wherein the apparatus is configured to automatically switch from the first mode to the second mode based upon a first time condition.

20. The food thawing apparatus of claim 19, wherein the apparatus is configured to automatically switch from the second mode back to the first mode based upon a second time condition.

21. The food thawing apparatus of claim 16, further comprising:
each of the fans having a heating element or a portion of a heating element proximate thereto on or in the divider wall.

22. The food thawing apparatus of claim 21, further comprising:
at least one heater positioned along the exterior lateral side of the first thawing chamber;
at least one heater positioned along the exterior lateral side of the second thawing chamber.

23. The food thawing apparatus of claim 21, wherein a first vertically extending heating element is provided within the divider wall and is positioned proximate the first sect of fans for heating the air, and a second vertically extending heating element is provided within the divider wall and is positioned proximate the second set of fans for heating the air.

24. The food thawing apparatus of claim 23, wherein:
the first heating element includes a first vertical leg and a second vertical leg, each of which is offset from a center region of the first set of fans; and
the second heating element includes a first vertical leg and a second vertical leg, each of which is offset from a center region of the second set of fans.

25. A food thawing apparatus, comprising:
a cabinet structure defining thawing chamber having a back side, a front side, a first lateral side and a second lateral side;
a plurality of fans arranged to create a plurality of looped air flow paths along respective heights of the thawing chamber, wherein the apparatus is configured to operate in a first mode in which the fans are operated to move air along the looped air flow paths in a first loop direction and a second mode in which the fans are operated to move air along the looped air flow paths in a second loop direction.

26. The food thawing apparatus of claim 25, further comprising:
a refrigeration system with at least one blower operable to pull air from the thawing chamber and return the air to the thawing chamber after cooling, wherein a vertical duct is provided in the thawing chamber for returning the air to the thawing chamber.

27. The food thawing apparatus of claim 26, wherein, in a refrigeration mode, the refrigeration system delivers cooled air to the thawing chamber via the vertical duct, wherein the blower and/or the vertical duct includes an associated heating element that is energizable during a thawing mode to add heat to the thawing chamber.
